(19) United States
(12) Patent Application Publication
(10) Pub. No.: US 2006/0224450 A1
(43) Pub. Date: Oct. 5, 2006

(54) System and Method for a Customer Loyalty Program and Storage Device

(75) Inventor: Jon Kenneth Moon, Edina, MN (US)

Correspondence Address: ORTHOX, LLC, 207 N. CHESTNUT ST., #225, CHASKA, MN, 55318, US

(73) Assignee: Orthox, LLC, Chaska, MN (US)

(21) Appl. No.: 11/278,811

(22) Filed: Apr. 5, 2006

Related U.S. Application Data
(60) Provisional application No. 60/594,403, filed on Apr. 5, 2005.

(51) Int. Cl. G06Q 30/00

(52) U.S. Cl. 705/14

(57) ABSTRACT

The system and method of this invention increases customer contact and affinity with a business through services and information provided via a data storage device. In one exemplary embodiment a retail business provides a targeted customer with a pocket flash drive unit customized with the business's logo on the outside and information specifically chosen for the customer in the device memory. The customer is encouraged to regularly patronize the business to obtain further information of value onto the flash drive.

### FIELD OF THE INVENTION

This invention relates to a system and method for an improved customer loyalty program. More particularly, the invention relates to a data storage device provided to the customer that can exchange information with a merchant through computer communications.

### BACKGROUND OF THE INVENTION

Retail and other businesses have traditionally advertised to large segments of the population, generally based on geography, and thus often to existing customers with the same message as intended for potential customers. Competition has made it more important to target marketing efforts to specific groups, such as high-margin or infrequent customers, in the context of a single business. Businesses that serve a large number of customers need to gather information to compile customer profiles for targeted advertising, marketing and promotions. Though it can be difficult to develop meaningful customer profiles to support targeted programs. If a store could accumulate more detailed customer-information, customer profiles could be developed and used for targeted advertising, marketing and promotional programs. Ideally, marketing programs would involve an exchange that equally benefits both the business and its customer. Many efforts at providing customers value in exchange for tracking their purchases and collecting other information have been attempted.

Retail stores have created “affinity” and “frequency” programs for their customers by issuing various types of “loyalty” or affinity cards. These could be punch or stamp cards that can be exchanged for something of value after a certain number of purchases, see FIG. 1. Another form of card bears an individualized number or a bar code that is associated with a customer in a database maintained by the retailer and that may be read with the same point-of-sale (POS) equipment used for purchases. Sometimes, more expensive magnetic stripe or “smart cards”, which may be loaded with customer information, may be issued to particularly valuable customers; customers who must also be willing to provide certain information and wait while such information is entered into the database system prior to the card being issued.

Despite their popularity among businesses, such cards have not been particularly successful. Use of the cards creates delays at checkout or even self-service terminals. Stores have found it difficult to get customers to provide personal information. Customers also do not wish to carry the myriad of cards issued by each business or forget to use such cards at checkout. More importantly, current affinity programs fail to reach the desirable individuals, such as infrequent and high-margin shoppers or even very frequent shoppers, because too many factors are involved. Such individuals may be less likely to carry or to use cards, or their perceptions of the value provided by the business may be highly variable.

A further problem with member or affinity cards is that the payment is made separately, by cash, check or credit/debit card. Deaton, et al. (U.S. Pat. No. 6,684,195) describe a “transaction processing system that uses a customer's financial instrument account number (check, credit card, debit card or the like) as a unique customer identification number”. This may speed checkout and obviate the need for a separate card or means of identification issued by the business. However, it would link the marketing (affinity) database maintained by the business with the credit card account number, at least in the minds of customers, if not in fact. Most customers would find this objectionable, especially with rising concern over and losses to identity theft.

Physical coupons or other discount tokens are by far the most common means businesses employ to attract new customers and influence their purchases. Physical coupons are largely ineffective for targeted marketing programs. Kepecs (U.S. Pat. No. 6,330,543), Sanders et al. (U.S. Pat. No. 6,739,514), Narasimhan et al. (U.S. Pat. No. 6,237,145) and Biorge et al. (U.S. Pat. No. 5,806,045) have proposed partial or total electronic systems and methods to achieve the functions of coupon programs. For example, the patent by Sanders et al. describes electronically storing coupons on a reader device to be used within a store or other business. Narasimhan et al. access coupons over electronic means with information and the type of coupon linked to user information that is converted to a paper coupon at the retailer or other business. Biorge et al. implement their system through a customer-carried device that contains multiple electronic circuits including a processor, interface and memory.

A limitation with all of these prior art systems is that the communications and devices are dedicated to the coupon-equivalent system. None of the equipment provides any direct benefit to customers other than for the purpose of storing or using coupons. Most of the devices would be too large or expensive to be retained by the customer. In other words, none of the systems or their components have any intrinsic value to the customer. It follows that customers' sole incentive to participate in a program is their perceived value of coupons and other rewards. If the business offers too few incentives or the wrong incentives customers could abandon the program or be won over to a competing program. This would harm the return to the business offering the program, especially if they have an investment in equipment that is retained by the customer.

Businesses have attempted to provide incentives or objects that could have some intrinsic value to a customer. One example of this is a beverage container marked with the business's logo or advertising that can be refilled for free or at a discount. More expensive beverage containers, such as insulated travel cups, are purchased by customers and include a certain number of free drinks. This helps the business to provide something of actual value to the customer without bearing the full cost by giving the container away.

One of the limitations of most incentive objects is that they are very specific to the business, such as the beverage container offered by a coffee shop. This limits the value to the customer and business when circumstances or buying patterns change. Also, there is no link to a particular customer and no information collected on their purchases or other behavior. Thus the goals of targeted marketing are largely defeated.

### SUMMARY OF THE INVENTION

An object of the present invention is to overcome the drawbacks described above and other limitations in existing systems by providing a customer loyalty system and method with generalized intrinsic value to a customer.

Another object of the invention is to provide a customer loyalty system and method whereby intrinsic value is provided to both a customer and the business or other entity offering a loyalty system through the same means.

Another object of the invention is to provide a dynamic customer loyalty system where the value of information exchanged by the customer and a business providing the invention increase with duration of participation and level of participation.

Another object of the invention is to provide a system and method for storing and manipulating information relating to individual customers participating in an affinity program that does not require personally identifying the customer to a business offering the program and that allows the customer to possess the sole copy of all such information.

Another object of the invention is to provide a system and method to store transactional, personal interest and other information that improves a business's marketing programs by collecting data that can be used to perform targeted marketing.

These and other objects of the invention are accomplished according to various embodiments of the invention. According to one embodiment of the invention, a customer is provided a standard data storage device that can be carried easily. The device may come preloaded with product or discount offers, software, internet links and other information of value to the customer. Also stored in the device could be an ID code and means to accumulate purchase or use history of the device relative to the program offered by the business that provided the device. The customer may use the storage device for their own purposes such as transporting computer files, music or other information they own. The value of the device can be further enhanced as the business provides the customer with additional information to use with the device. The information could be made available at a business retail location, over the internet, or by some other means appropriate for the business's marketing purposes. At the time of the transfer the customer could provide feedback on the perceived value of the information directly, by such means as a survey response or accepting further information of a particular type, or indirectly such as by a record of access to the information. Additional feedback from the customer could consist of a ‘Suggestion Box’ solicitation. Customers would be encouraged to submit better service and product offering suggestions for example. Business retail employment opportunities would constitute supplementary content of interest.

### BRIEF DESCRIPTION OF THE DRAWINGS

FIG. 1. Affinity program punch and bar coded cards of the prior art.

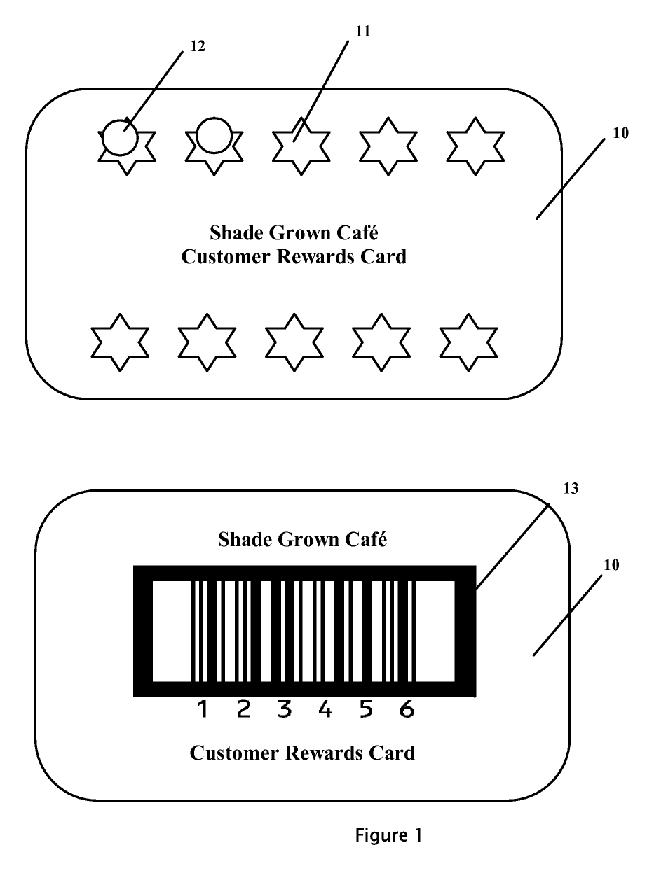

FIG. 2. Isometric views of the data storage device of the present invention.

FIG. 3. Isometric views of the data storage device of the present invention containing prior art affinity means.

FIG. 4. Block diagram of the data storage device and host systems of the present invention.

FIG. 5. Flow diagram of steps in the method of the present invention.

### DETAILED DESCRIPTION OF THE INVENTION

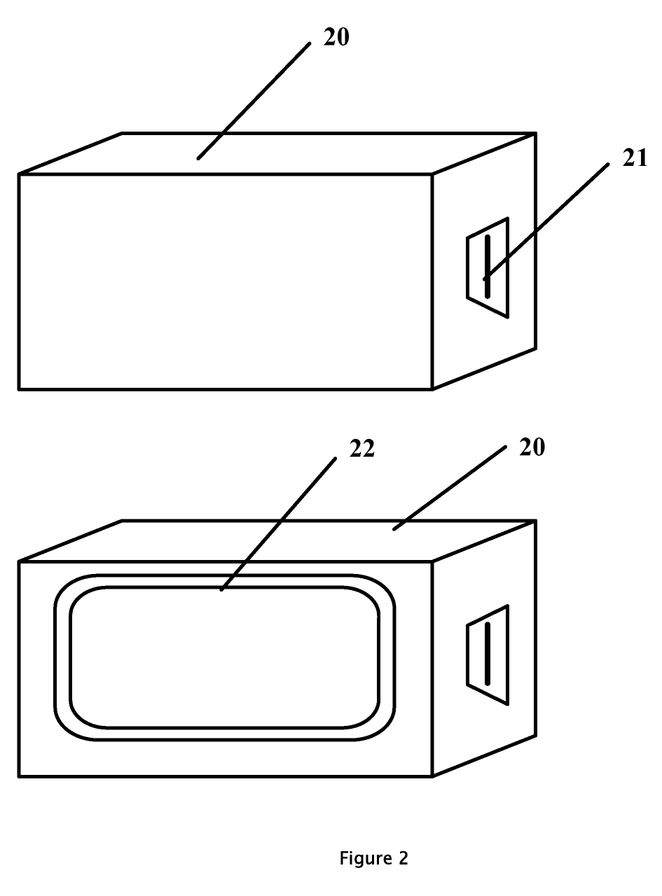

A variety of portable personal data storage devices have become popular for a number of applications. As exemplified in FIG. 2, some devices provide readily transportable data storage 20 with a common computer interface 21, such as a Universal Serial Bus (USB) connection. Data may also be stored electronically within portable interactive devices, such as portable telephones, music players (e.g., ipod or MP3), personal digital assistants or even digital cameras. This invention describes a system and method for any one or all of these devices to be used in a mutual reward (affinity) program offered by a business or other entity to its clients or customers.

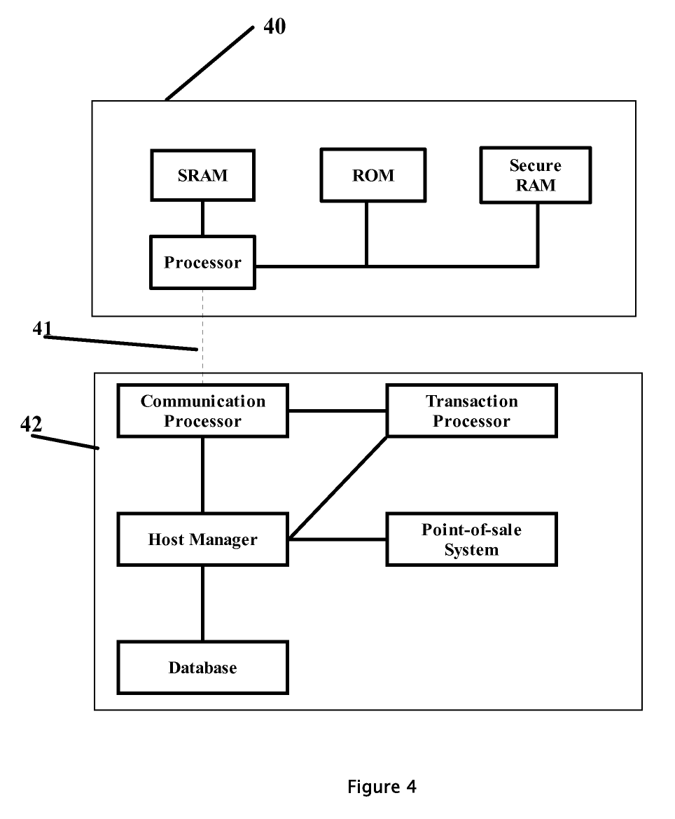

The system of this invention, as illustrated in FIG. 4, includes one or more components of the type: a portable electronic data storage device 40; communications means for exchanging data with the portable storage device 41; and a “host” system 42 that allows the business to implement the affinity program. The host system may comprise: a communications processor to control communications and data exchanged with the storage device; a host manager that stores and implements the loyalty and reward program defined by the business; a database that contains information received from and available to the portable storage device; and a transaction processor that monitors communications, data exchange and the data stores to ensure security, integrity and implementation of exchange rules. The host system may have a connection to the point-of-sale (POS) or other transactions processing system operated by the business.

Storage device circuit 40 comprises one or more of the components shown in FIG. 4: random access memory (RAM) accessible by the user implemented as SRAM, DRAM or flash memory; read-only memory (ROM); secure RAM or secure flash memory and a processor to manage memory and provide communication with external systems. Intercommunications path 41 comprises any of the physical communications presented for physical contact 21 and wireless 22, described below, and associated collision/handshaking techniques known in the art. One preferred embodiment of an external host system 42 comprises one or more of a host Communication Processor circuit compatible with the storage device; a Transaction Processor for validating information exchange with storage device circuit 40 (described in more detail below); a Host Manager to organize information exchanged with the storage device circuit; a Database that contains customer information and information that may be provided to storage device 20; and communication with a Point-of-Sale system (POS).

According to one embodiment of the invention, a customer is provided a standard data storage device that can be carried easily. The device may come preloaded with product or discount offers, software, internet links and other information of value to the customer. The customer may use the storage device for their own purposes such as transporting computer files, music or other information they own. The value of the device can be further enhanced as the business provides the customer with additional information to use with the device. The information could be made available at a business retail location, over the internet, or by some other means appropriate for the business's marketing purposes.

It might be particularly convenient for the customer, at the time the new information is transferred, to provide feedback on the perceived value of the information directly, by such means as a survey response or accepting further information of a particular type, or indirectly such as by a record of access to the information. Of course, other ways for the customer to provide feedback could be arranged, including over the internet or in response to a paper or electronic survey.

The device could store an ID code and means to accumulate purchase or use history data within the device relative to the program offered by the business that provided the device. Purchase and use history could include number of items or currency value purchased, store visits, and the dates and intensity of accesses (uploads and downloads). This information would then be related to the value, level or type of information, product or service provided to the customer by the business. All of this information, or any part, could be stored in the device in a properly configured database. Some or all of the information could be secured to prevent alteration or access by either the customer or the business through any computer-compatible means of encryption or signing. In this manner both parties can be assured of the privacy, integrity and security of the stored data on the device retained by the customer.

Unlike prior art systems, the system and method of this invention will enable stand-alone operation at an individual business location, and can maintain at that business a local database of customer records. The customer records can be identified by a unique customer ID code to ensure security and provide anonymity to the customer if this is desired. The customer records could be limited to those minimally needed to operate the customer loyalty program designed by the business. And the records could be extended to include customer information provided voluntarily by the customer as well as selected transactional data (such as transaction frequency and dollar volume). The data being regularly updated with new data each time the device is linked to a communication system in the business. By storing data on the device retained by the customer, the business does not need to be linked to a central database with concurrency processing and other costly requirements. This type of configuration might be particularly appropriate for several situations:

smaller or remotely-located businesses with few locations or limited data handling infrastructure
trial runs of a loyalty or other marketing program
temporary or seasonal programs such as festivals, markets, conferences and conventions, or classes
geographically based programs where participating businesses or program partners lack information infrastructure or have existing but incompatible infrastructure, such as a program run by the chamber of commerce in a community

The system and method of this invention would also be compatible with, and enhance, traditional loyalty and affinity programs, including those with substantial information infrastructure that includes local data entry points, POS systems, and central database operations.

In addition to the data storage device, the system includes one or more communication means at a business location, such as kiosks, terminals or transmitters. Communication with the storage device will be by any one or more of the several computer-compatible means, well known in the art, such as contact-based ports 21 (universal serial bus (USB), RS-232, 1394), near-contact (magnetic, induction, scan) and distant 22 (Bluetooth, WiFi, infrared, UWB). When a plurality of communication means are provided one or more may be reserved for one-way communications or for simpler operations such as detecting proximity. Communication can be continuous as long as an authorized storage device is within communication range of a communication means with sufficient capacity. Or, communication can be periodic (based on time), or episodic (initiated by the customer, via a button or other input device, or initiated by the business). Periodic or continuous communication may be used to establish the location or duration that the storage device is within range of the communication means, and thus characterize the visit of a customer to the business location.

A USB 2.0 interface comprises one preferred embodiment of contact communication via port 21. Important characteristics and performance of USB 2.0 include:
1) The USB is a 4-wire configuration consisting of +5V (Red), Ground (Brown), and

twisted data pair (Yellow & Blue). It provides a maximum of 500 mA @ 5V and is hot-swappable.
2) The host/USB memory stick requires an ‘A’ connector.
3) The host system with a USB hub(s) can accommodate 127 devices (serving multiple customers' storage devices 20) simultaneously.
4) Host system auto-detects and queries all devices on the bus and assigns an address. It also determines from each device the type of data transfer it wishes to perform.
5) The host sends commands or query parameters with ‘control packets’ and is capable of a maximum data rate of 480 MBits/sec.

The communication processor receives a customer communication request through the communication means. The processor authorizes or denies the communication by using the customer ID code, an ID assigned to the storage device or some other identifier, to search a database, to retrieve the corresponding customer record and to determine the status of the customer or storage device. Alternatively, the customer record database may stored on the host subsystem which receives the communication request and ID from the communication processor. Based on the customer information in the customer record the communication request can be approved and the level of access or service can be forwarded to the communication processor and to the storage device. If there is no customer or ID record the host may set a level of access determined by the business providing the program or may notify some other system, the customer or business personnel of the communication attempt and status. Possible actions that may be taken by any of these entities include locating a possible fault, offering membership in the program to the customer or responding to the communication request with a specific notice and information.

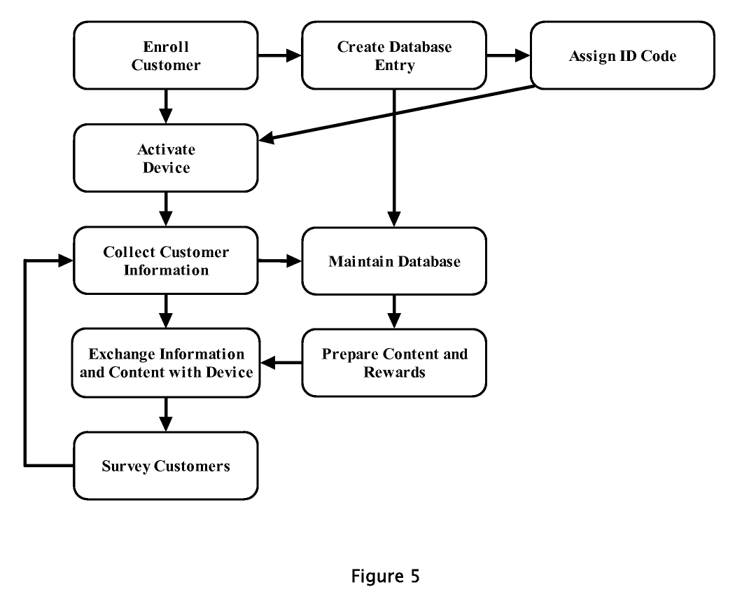

FIG. 5 illustrates steps in the method of this invention by providing any or all of the various aspects of:

(1) enrolling a customer in a loyalty or other program;

(2) providing the customer with and activating a portable data storage device or creating a record and communication link to a device already owned by the customer;

(3) creating or assigning an identifying (ID) code to the customer that is pre-set on the storage device;

(4) obtaining information from the customer such as identification, interests, and preferences;

(5) developing and maintaining for the business a local customer database of customer records associated with the ID code or linking the ID code to existing customer information maintained by the business;

(6) generating a unique customer information package of data and software based on the information in the database and rules for the affinity program defined by the business;

(7) loading the information package onto the storage device;

(8) extracting or uploading information from the storage device, processing information and adding it to and updating the customer database;

(9) reprocessing the information in the customer database to create the a new information package for the customer, and other customers, according to rules defined for the affinity program by the business.

The system and method of the invention provides targeting of individual customers with benefits and rewards that can be based upon their history of interaction with the business, including purchases, downloads, use of services and responses. For example, when the storage device is linked to the communication means at a business location POS coupons or other sales incentives may be targeted specifically to the customer based upon this prior history. Use of the storage device with an internet-linked computer anywhere (not restricted to a business location) can automatically direct the customer to a web site related to the business where further interaction can take place and additional rewards can be earned by the customer. An alternate use of the storage device with a computer, that does not require either an internet connection or proximity to the business location, includes recording interactions with data or programs stored on the storage device that can earn rewards for the customer. This could be something as simple as earning a fraction of a cup of espresso each time the storage device is connected to a computer, or a more complex interaction where the time spent with a particular software application or the score in an interactive game is converted to some reward. Further means of providing customers with rewards based upon their interactions are described below. In general, the invention gives businesses new and much more efficient means for creating affinity with a customer.

The invention provides novel methods for businesses or other entities to interact with customers and supply rewards with greater perceived value to the customer with increased efficiency. The method and systems of this invention also accommodate the level of technical sophistication and resources of the business or entity that utilizes the invention.

The various embodiments of the invention described below may be taken in sequence from an entry point appropriate for the business or be implemented individually.

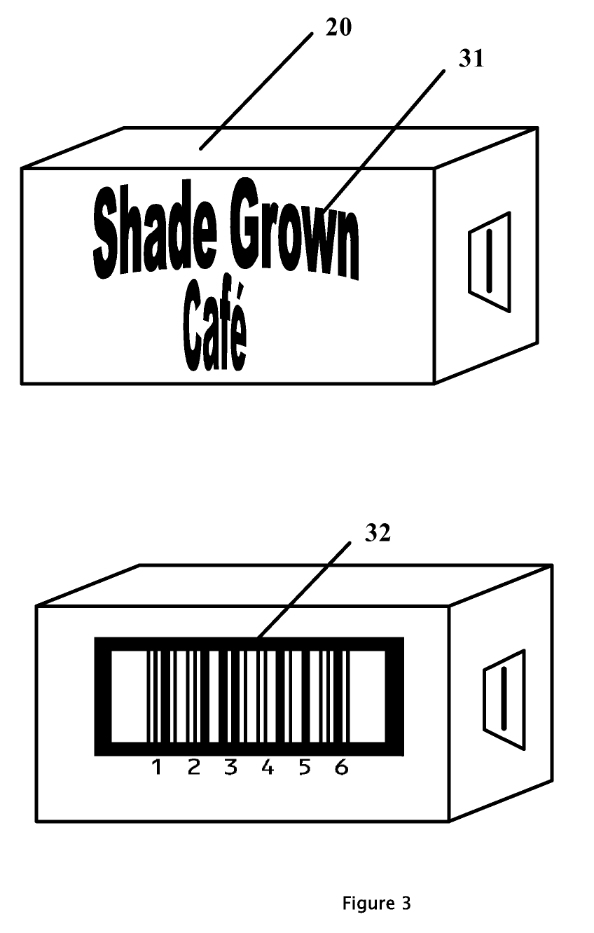

FIG. 2 helps describe one embodiment of the invention. The storage device 20 is presented as a flash drive, memory stick, SD card or similar unit among the various types popular for use with computers, digital cameras, cell phones or game devices. The device could be provided with a unique housing modified by shape, color, and logo to represent the business, 31 in FIG. 3. There could also be provided, either affixed to or imprinted on housing, an unique barcode that would function identically to the barcodes imprinted on existing affinity cards and able to interact with an affinity system already in use by the business 32. The customer receives a device with a significant value to them beyond its use as an affinity marker and would therefore be likely to carry it and make frequent use of it. When the customer uses the flash drive in public he or she would further provide advertising for the business by way of the imprint.

The device could be configured (by storage capacity, accessories, housing configuration) to closely define the value expected to be perceived by the customer. This would allow the business to recover some or all of its cost to provide the device by selling it to the customer. The goal with a particularly simple device would be to sell it at a price below that commonly available at electronics retailers. However, a business providing the device might be able to increase value to their customer, even when pricing the device at common retail levels, simply by vending it at its locations, thus providing substantial convenience compared to electronics or computer stores where storage devices are usually sold.

Customers of businesses with a sophisticated or popular image could perceive some benefit in carrying a product with a well-known or popular logo. Further value could be created by providing differentiation among a collection of storage devices offered by the business based on the housing (such as silver, gold and platinum levels used in stratifying credit card customers), storage capacity or other features. As an alternative, the business could provide the devices in a stratified manner to customers with particular buying habits or to encourage a change in purchasing behavior.

In an alternative embodiment, not exclusive of other embodiments, data or software may be pre-loaded on the storage device prior to being provided to the customer. The data or software loaded at the time of production or prior to distribution may be updated with improvements learned through interaction with customers or as additional valuable data is collected. In general, no maintenance by the customer or business is required. Thus no communication means or other equipment must be provided by the business. Additional data or software may be provided to the customer via the internet and the customer's computer from a web site or other service provided by the business.

The data and software loaded on the storage device may be of any nature that would be perceived by the customer as providing additional value to the device and the affinity program. The business may prefer to supply information that more specifically relates to the business's products or services. For example, a coffee shop might choose to provide a guide to coffee types, grades, and production and storage practices (shade grown, fair trade, etc), as well as further specific information on how each coffee offered by the business is selected, roasted and brewed. There may also be software provided on the device that supports purchases at the business. For example, the software could provide the menu of a take-out or catered food service as an order form, or pick list for a hardware store that includes product location. The forms or other output of the software could be printed or sent to the business so that products or services desired would be waiting at the business or be delivered and an electronic delivery ticket matched for accuracy against the list stored on the device. For any business the stored information could include company locations, coupons or discounts provided with the storage device as a reward for enrolling in the program. Other preloaded software could include entertainment material, games or utilities such as antivirus.

The information loaded on the device could be arranged to appear whenever the customer connects it to their computer or accesses a self-contained device. In one preferred configuration the customer would be presented with their personal and activity information in the affinity program. They could see records of purchases, rewards, contact information, survey results and status. This would tell them what was needed to reach another level of reward or status and give them a chance to correct any errors. To retain goodwill it should be easy for the customer to bypass the automatic presentation of the information and quickly access the other functions of the device. The business may define the automatic presentation and bypass method to best present their message and avoid annoying the customer.

A particular category of preloadable information could be of the form to directly support the product or service offered by the business. This category may be described by reference to the example of a travel agency. The agency would provide a customer with the storage device prior to departure. Information provided on the storage device would be quite extensive and include: travel itinerary (preferably in an interactive format such as hypertext), background information on all the places to be visited (museums, restaurants, parks), maps, transportation schedules, guidebooks, language books and lessons, currency converter data and application software, expense record software, medical information, copies of travel documents, and emergency information. It is unlikely the customer could, on their own, assemble all of this information specific to their travel plans in formats that could be stored on an electronic device; and carrying printed materials of equivalent capability would be prohibitively bulky, heavy and expensive. The agency would have much less difficulty creating a travel package for each customer from a master database of such information. The relationship between the travel agency and customer would be enormously strengthened. The storage device could be re-used by the same customer for later travel or their own use, or returned to the travel agency for use by another customer.

Another example of preloadable information provided to customers with the storage device in support of a service is that of an affinity program for a health club. Prior to an exercise session the customer could load their storage device with music or a recorded book through communications means in the health club. The storage device could be a component of a device already capable of audio playback or the storage device could be linked to a playback device provided by the health club. The type or quantity of information downloaded may be stratified by the membership level of the customer. During exercise information on the workout may be recorded in the storage device such as duration, intensity and physiologic response (especially recording of heart rates). The health club can offer services to analyze the exercise records through software. The advice of a trainer or training software can be applied to prepare an exercise plan, estimate benefits and monitor/evaluate adherence. The exercise record could also be used to provide the customer with rewards mediated through the health club system, including access to a higher level of information that can be loaded on the storage device or even discounts from a health provider.

Yet other examples of service partners include airlines and video rental businesses. Airlines have great difficulty providing reading and viewing material to passengers without occupying too much room on the aircraft and cluttering the cabin. At the time of embarkation the passenger can connect the storage device to a kiosk near the gate and download their choice of media. The airline could also load the itinerary, ticket information, sales offerings (such as in-flight duty free) and information related to their affinity program (progress to next reward level, etc). Passengers at low reward levels in the affinity program might pay a fee to access premium materials that would be offered for free to passengers at a higher level. The storage device may also be loaded with information to serve as a the electronic equivalent of a pre-printed boarding pass. Capacity on electronic storage devices is already approaching that needed to contain full-length videos or movies. Airlines, travel agents and video businesses can offer each passenger or customer a unique choice of program without any physical media belonging to the business. Because the storage device can be identified uniquely and can contain encryption codes, circuits or software, copying or accumulation programs can be prevented.

Yet another embodiment of the invention, not exclusive of other embodiments, provides for frequent electronic interaction between the customer and business via the storage device. The types of information that the business might make available could include, but is not limited to:

New product, clearance and sale information.

When an active shopping or pick list is present on the storage device at the time it is connected to the communication means various relevant information could be automatically downloaded to the storage device for use by the customer, including rebate forms, product manuals, warranty statements, and customer service information.

Presentation of special discounts available for a limited time or only to specific customers either randomly or based on the information on the storage device or in the customer database. The discounts could be downloaded to the device via the internet or communication means in the business location, printed on paper at a kiosk or uploaded to the business POS system. Discounts presented via the internet could be transported to the business location on the storage device or be triggered at the business location when the storage device is recognized by the communication means.

Daily readings, extracts from or entire newspapers, magazines or e-books;

Games, preferably based on the client's products or services;

Quizzes or trivia questions;

A story, adventure, or mystery in serial form, with a new installment available every day to product users;

A daily contest or lottery, with the customer device ID serving as the lottery or contest entry number;

Music, audio recordings (e.g. readings of news and books), cartoons, video (clips or movies);

Automatic antivirus scanning or download of updates to antivirus software;

Parking validation certificate.

Providing information to customers via the web offers several advantages. The business need not purchase any equipment, and customers can interact with the business and access new information at their convenience. On the other hand, when the customer is not required to be physically at the business location to participate there is less opportunity for the business to benefit from the affinity program by encouraging the purchase of its goods or services. Employing kiosks or a wireless communication means operable only in proximity to the business location offers the advantage of requiring the customer to be physically present at a retail location and of allowing greater control over content. It would be possible to segregate the information offered by the business into that provided only at the business location or in connection with service being provided (higher value or more immediate interest), and information available anywhere to customers enrolled in the program.

Yet another embodiment of the invention, not exclusive of other embodiments, provides for transactional information at any level of value that would be exchanged between the business and customer via the communication means. This, for example, would allow customers to track progress toward free merchandise or services, or book or earn meeting services or internet usage time. Specific currency value may be placed in the storage device, either for customer convenience in making purchases, as a reward in the affinity program or so the product could serve as a the equivalent of a “gift card”. This embodiment envisions capability added to the invention at each element to handle encrypted and verifiable information and to interact with the sales or accounting systems of the business.

USB and similar ports are inexpensive, and security concerns would be limited so long as active ports are connected to a simple, stand-alone, internet-connected PC. Transactional information could be loaded in other ways, including action by a clerk. Direct, real-time exchange of information between the device and the client's systems would demand that security concerns be addressed. We believe that these can be shown as comparable to any existing risks.

In yet another embodiment of the invention, that is not exclusive of other embodiments, the storage device, as provided, contains specialized circuitry or components. Portions of the electronic storage on the device can be isolated or secured to resist tampering, attack by malicious software or limit access. These means could involve permanent software codes or keys, separate communication pathways or signal lines, physical indicators on the device (such as an LED) that indicate when the separate storage is being accessed, or a button on the device housing that must be pressed to allow access. The separate memory could be of a type that is specialized to provide faster access or processing than the non-volatile memory (which retains information when power is removed) used for the bulk of the device.

The invention may also be used by the business to assist customers in obtaining and using certified digital ID and personal certificates. Such certificates are required to secure electronic messages and files by encryption or digital signature. In one preferred embodiment the business establishes a relationship with a certificate issuing authority, such as Verisign or Thawte, to verify the identity of the customer and provide means for customers to obtain the certificate. The digital storage device serves receive the certificate code and related data. Specialized circuits, such as those described above, may be incorporated into the storage device to support digital ID use. The host systems may also incorporate verification facilities such as a fingerprint input device. Because there is personal contact between the business and customer the business may serve as a notary in a “web of trust” system to upgrade and maintain the status of the customer. Or the device may serve as a particularly secure means of identifying the bearer.

Another function that could be provided with the storage device is of the type exemplified by a radio-frequency identification (RFID) circuit. An RFID of the type well known in the art may be incorporated into the housing or on the circuit module of the device. The RFID could identify the device wirelessly to the communication means at the business location to provide essential information that allows the customer to benefit from the affinity program without establishing communication between the primary circuits on the storage device. As both RFID and standard electronic storage circuits are manufactured in great quantities relatively inexpensively combining the two can provide the most efficient functions of both limited wireless communication and high-capacity communication through a physical connection.

Various characteristics and advantages of the invention covered by this document have been set forth in the foregoing description. This disclosure is only illustrative in many respects. Changes can be made in details without exceeding the scope, or departing from the spirit, of the invention. The inventors' scope is defined in the language in which the claims are expressed.

What is claimed is:

1. A method for managing a relationship program between a business and a customer comprising:
enrolling the customer in the relationship program,
creating a profile of the customer in a database of the relationship program;
activating a data storage device for use by the customer in the relationship program;
offering information to the customer that can be stored on the storage device according to a set of rules defined by the business to promote customer affinity;
allowing the customer to choose information to store onto the storage device;
requiring that the customer and data storage device be in one of a set of physical locations selected by the business; and
recording the customer information choices in the profile.

2. The method of claim 1 further comprising the step of providing the data storage device to the customer.

3. The method of claim 2 further comprising the step of storing information on the data storage device prior to enrolling the customer.

4. The method of claim 1 further comprising the step of choosing specific information to offer to customer based on the profile of the customer.

5. The method of claim 1 further comprising the step of adding information provided voluntarily by the customer to the profile of the customer.

6. The method of claim 1 further comprising the step of adding information from customer choices of information to store on the storage device to the profile of the customer.

7. The method of claim 1 further comprising the step of adding information from customer responses to survey questions to the profile of the customer.

8. The method of claim 1 further comprising the step of offering the customer information based on their history of purchases from the business.

9. The method of claim 1 further comprising the step of providing the customer with discounts on products or services stored on the storage device.

10. A system for managing a relationship program between a business and a customer comprising:
a first data storage device in the possession of the customer for storing information provided by the business;
a first database containing information that the business can provide to the customer;
a second database containing a profile of the customer;
a third database containing rules defined by the business for providing information from the first database to the customer based on the customer profile in the second database;
a host processing system comprising at least one processor and a second data storage device that holds said first, second and third databases;
said host processing system further comprising computer executable code to process said rules in said third database to select and provide information to the customer; and
a communications means that transfers information to said first data storage device according to said rules.

11. The system of claim 10 wherein said first data storage device is a flash drive.

12. The system of claim 10 wherein said first data storage device is a portable audio player.

13. The system of claim 10 wherein one of said rules defines the physical location and configuration for the customer and first data storage device.
